(19) United States
(12) Patent Application Publication
(10) Pub. No.: US 2009/0183946 A1
(43) Pub. Date: Jul. 23, 2009

(54) Portable Access Ladder

(76) Inventor: Edward Andrew Prebola, West Pittston, PA (US)

Correspondence Address: Ashok Tankha, 36 Greenleigh Drive, Sewell, NJ, 08080, US

(21) Appl. No.: 12/356,535

(22) Filed: Jan. 21, 2009

Related U.S. Application Data
(60) Provisional application No. 61/022,532, filed on Jan. 22, 2008.

(51) Int. Cl. E06C 5/00

(52) U.S. Cl. 182/127

(57) ABSTRACT

Disclosed herein is a portable apparatus for accessing an elevated area on an automobile. The portable apparatus comprises a central element, a hook plate, and load supporting members. The central element comprises an upper section and a lower section. The hook plate is affixed to the upper end of the upper section of the central element. The hook plate secures the central element to the automobile. The load supporting members are positioned laterally on the lower section of the central element. The load supporting members enable a user to access the elevated area on the automobile and to ascend and descend the automobile. Adjustment wings may be provided on the hook plate and extended on both sides of the hook plate for fitting the hook plate in stake pockets of different sizes provided on the automobile. The portable apparatus is lightweight and easy to use, store, and install.

### CROSS REFERENCE TO RELATED APPLICATIONS

This application claims the benefit of provisional patent application No. 61/022,532 titled “Portable Steps for Accessing An Automobile”, filed on Jan. 22, 2008 in the United States Patent and Trademark Office.

### BACKGROUND

This invention, in general, relates to a ladder. More particularly, this invention relates to a portable apparatus for accessing an elevated area on an automobile.

Commercial automobiles, for example, tractors, trailers, trucks, vans, cabs, etc., in general, contain a cargo containment apparatus for carrying cargo. In many cases, the cargo is positioned at an elevated platform such as a deck on the automobile. In order to perform different tasks such as securing, protecting, inspecting the cargo, etc. a driver of the automobile needs to access any elevated area on the automobile with ease. Most commercial automobiles do not include any apparatus for providing safe access to the elevated platform containing the cargo. Moreover, the driver of the automobile may use unsafe means such as tires, brackets, or bumpers to ascend to the cargo containing area. Since these means are not intended for accessing the elevated platform on the automobile, accidents may occur due to slips or abrasions. The driver may also descend from the cargo level by jumping to the ground level, possibly resulting in injuries such as sprains, bone fractures, repetitive impact injuries, etc.

Hence, there is a need for a portable apparatus that enables a user to access an elevated area on an automobile with comfort, ease, and safety.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The portable apparatus disclosed herein addresses the above stated need for enabling a user to access an elevated area on an automobile with comfort, ease, and safety. The portable apparatus comprises a central element, a hook plate, and load supporting members. The central element comprises an upper section and a lower section for supporting the load supporting members. The upper section may be oriented vertical to a flat surface. The load supporting members are positioned laterally on the lower section of the central element. The load supporting members enable a user to access the elevated area and to ascend and descend the automobile. The lower section may be inclined with respect to the upper section for enabling a user to ascend and descend the automobile using the load supporting members with comfort and ease. The load supporting members may be positioned horizontally and perpendicularly to the lower section of the central element. The load supporting members may be alternately placed in opposite directions on the lower section of the central element.

The hook plate is affixed to the upper end of the upper section of the central element. The hook plate secures the central element to the automobile. A tube may be affixed atop the hook plate. A securing element is inserted in the tube to secure the hook plate to the automobile. The hook plate fits within a stake pocket of the automobile. The hook plate fitted into the stake pocket bears the load of the portable apparatus and the user. Adjustment wings may be provided on the hook plate and extended on both sides of the hook plate for fitting the hook plate in stake pockets of different sizes. The adjustment wings may comprise openings for inserting fasteners. The fastener fastens the adjustment wings to the hook plate after the extension. The portable apparatus may further comprise a bracket for securing the hook plate to the automobile in the absence of a stake pocket in the automobile. The portable apparatus disclosed herein is lightweight and easy to use, store, and install.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a front view of a portable apparatus for accessing an elevated area on an automobile.

FIG. 2 illustrates a side view of a portable apparatus for accessing an elevated area on an automobile.

FIG. 3 exemplarily illustrates a securing element used for inserting into a tube affixed atop a hook plate of the portable apparatus to secure the hook plate to an automobile.

FIG. 4 exemplarily illustrates the portable apparatus attached to a stake pocket of an automobile.

FIG. 5 exemplarily illustrates a hook plate of the portable apparatus with adjustment wings.

FIG. 6 exemplarily illustrates a bracket for use in the absence of the stake pocket on the automobile.

FIG. 7 illustrates a method of accessing an elevated area on an automobile.

### DETAILED DESCRIPTION OF THE INVENTION

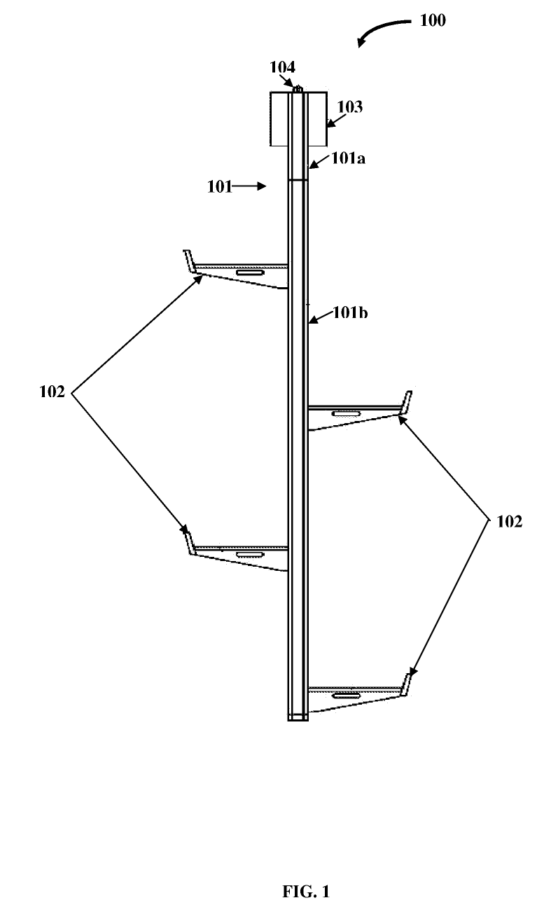

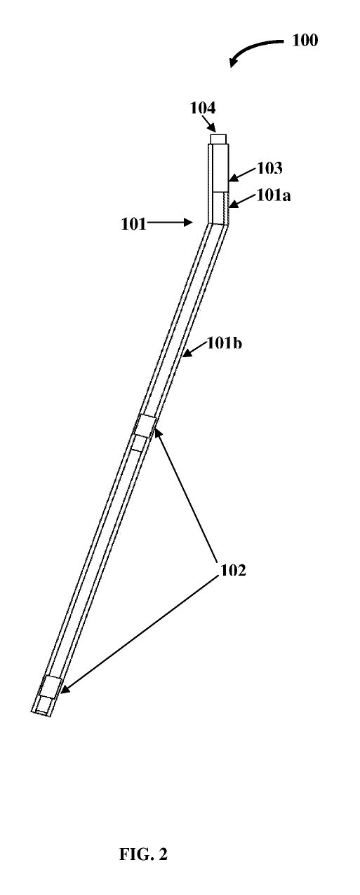

FIG. 1 illustrates a front view of a portable apparatus 100 for accessing an elevated area on an automobile. The portable apparatus 100 is herein referred to as an “access ladder”. The access ladder 100 comprises a central element 101, a hook plate 103, and multiple load supporting members 102. The central element 101 may, for example, be a rod shaped structure. The central element 101 comprises an upper section 101a and a lower section 101b for supporting the load supporting members 102. The upper section 101a may be oriented vertical to a flat surface, for example, a ground surface. The lower section 101b may be inclined with respect to the upper section 101a for enabling a user to ascend or descend the automobile using the load supporting members 102 with comfort and ease. The user may be a driver of a truck, a worker, a laborer, etc. A side view of the access ladder 100 illustrating the vertical upper section 101a and the inclined lower section 101b is exemplarily illustrated in FIG. 2.

The load supporting members 102 are positioned laterally on the lower section 101b of the central element 101. The load supporting members 102 may, for example, be wedge shaped structures extending outwardly from the central element 101. The load supporting members 102 enable a user to access the elevated area on the automobile and to ascend or descend the automobile. The load supporting members 102 may, for example, be steps or rungs. The load supporting members 102 may be positioned horizontally and perpendicularly to the lower section 101b of the central element 101. The load supporting members 102 may be alternately placed in opposite directions on the lower section 101b of the central element 101.

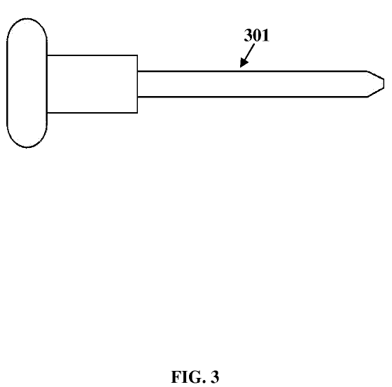

The hook plate 103 is affixed to the upper end of the upper section 101a of the central element 101. The hook plate 103 secures the central element 101 to the automobile. The hook plate 103 may, for example, comprise two parallel planar structures 103a and 103b joined by a third planar structure 103c oriented orthogonally to the two parallel planar structures 103a and 103b, as exemplarily illustrated in FIG. 5. A tube 104 may be affixed atop the hook plate 103. A securing element 301, as exemplarily illustrated in FIG. 3, may be inserted into the tube 104 to secure the hook plate 103 to the automobile. The securing element 301 may, for example, be a safety pin. A lanyard may, for example, be used to secure the securing element 301 to the central element 101 to prevent displacement of the securing element 301.

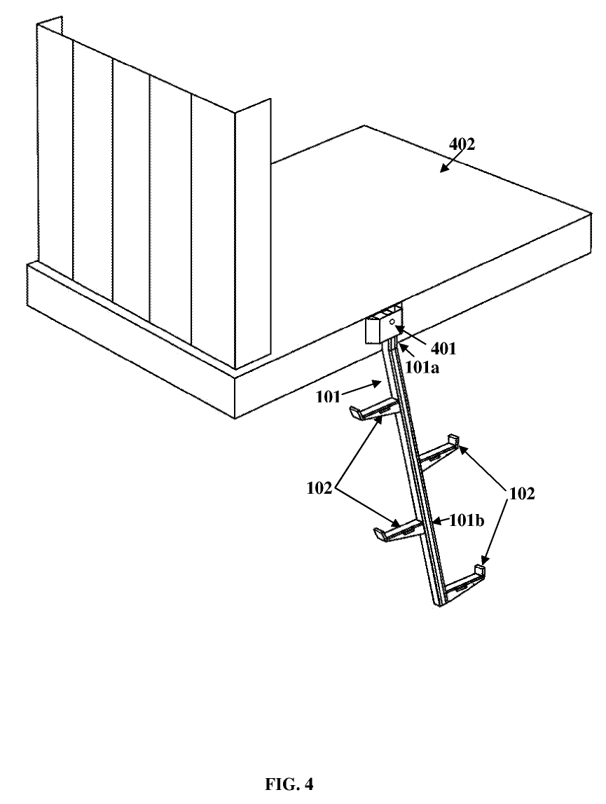

The hook plate 103 may fit within a stake pocket 401 of the automobile, as exemplarily illustrated in FIG. 4. The hook plate 103 fitted into the stake pocket 401 bears load of the access ladder 100 and the user. The hook plate 103 may be fabricated to slide through the stake pocket 401. A clearance may be provided between the hook plate 103 and the stake pocket 401 to enable ease of assembly of the access ladder 100 with the automobile. The clearance is minimal enough to limit lateral movements of the access ladder 100, for example, forward-backward and left-right movements with respect to the automobile. When the hook plate 103 affixed to the central element 101 is slid up through the stake pocket 401, a “close fit” of the hook plate 103 and the stake pocket 401 provides stability as the weight of the user's body alternates from a left step to a right step on the load supporting members 102. The “close fit” prevents a pendulum action of the central element 101 as the user ascends or descends the access ladder 100. The load supporting members 102, the hook plate 103, and the stake pocket 401 together sustain the load of the user and the access ladder 100.

Typical stake pockets 401 may be of different sizes, for example, 3 inches, 3.5 inches, etc. In order to make the hook plate 103 usable with the stake pockets 401 of different sizes, adjustment wings 501 may be provided on the hook plate 103, as exemplarily illustrated in FIG. 5. The adjustment wings 501 extend outwardly on either side of the hook plate 103. The adjustment wings 501 may, for example, be rectangular structures. The user extends the adjustment wings 501 on both sides of the hook plate 103 for fitting the hook plate 103 in stake pockets 401 of different sizes. The length of the extension on either side of the hook plate 103 may be adjusted by the user. The adjustment wings 501 may comprise openings 502 for inserting fasteners. The fasteners fasten the adjustment wings 501 to the hook plate 103 after the extension. The fasteners may, for example, be nut and bolt assemblies, screws, or rivets. The adjustment wings 501 may be extended in increments of, for example, ⅛ inches or ¼ inches to allow the hook plate 103 to be fitted into stake pockets 401 of different sizes. The hook plate 103 may be manufactured to fit small stake pockets 401 without use of the adjustment wings 501. For fitting the hook plate 103 in larger stake pockets 401, the adjustment wings 501 may be used. The adjustment wings 501 may be secured to the hook plate 103 using, for example, countersunk bolts, nuts, rivets, screws, and other fasteners. The adjustment wings 501 help the hook plate 103 and the stake pocket 401 to achieve a “close fit”.

The access ladder 100 is assembled on the automobile by sliding the hook plate 103 upward through the stake pocket 401 of the automobile and securing the hook plate 103 to the stake pocket 401. The securing element 301 is then inserted into the tube 104. Once the access ladder 100 is assembled on the automobile, the user may step on the load supporting members 102 and access the elevated platform 402, for example, a truck deck on of a truck.

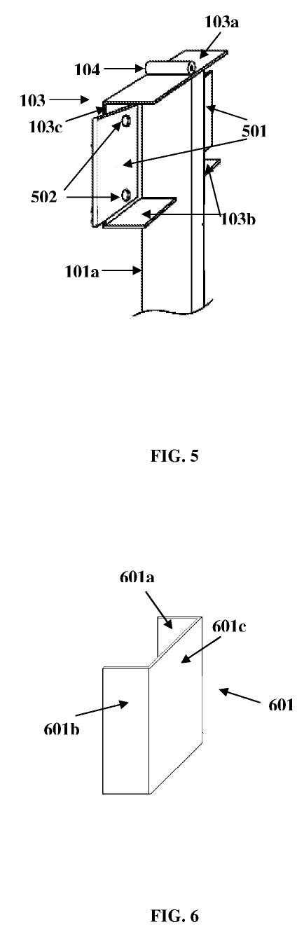

A bracket 601 as exemplarily illustrated in FIG. 6 may be provided for securing the hook plate 103 onto the automobile in the absence of the stake pocket 401 on the automobile. The bracket 601 may, for example, comprise two parallel planar structures 601a and 601b joined by a third planar structure 601c oriented orthogonally to the two parallel planar structures 601a and 601b, as exemplarily illustrated in FIG. 6. The access ladder 100 may be disassembled after usage, from the automobile by removing the securing element 301 from the tube 104. The hook plate 103 is disengaged from the stake pocket 401 by elevating and minimally rotating the central element 101. The access ladder 100 is then pulled out of the stake pocket 401 by sliding the hook plate 103 downward through the stake pocket 401.

The access ladder 100 may be used for different practical applications on the automobile. For example, the user may assemble the access ladder 100 in conjunction with the automobile at an elevated platform 402 as exemplarily illustrated in FIG. 4, and uses the load supporting members 102 on the central element 101 to ascend from the ground level and carry out tasks such as securing, inspecting, and protecting the cargo from a suitable and comfortable position. The user may use the access ladder 100 to reach and climb over the cargo area to load cargo onto the automobile or unload cargo from the automobile. The user may also use the load supporting members 102 to descend to the ground level from the elevated platform 402.

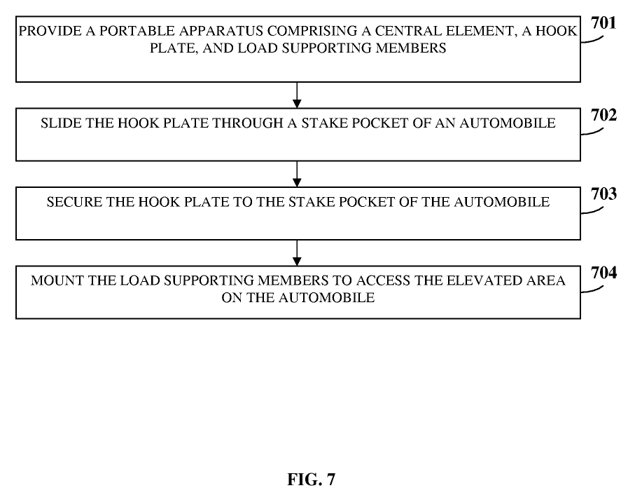

FIG. 7 illustrates a method of accessing an elevated area on an automobile. An access ladder 100 for accessing the elevated area on an automobile is provided 701. The elevated area may be a platform 402 on the automobile. The access ladder 100 comprises a central element 101, load supporting members 102, a hook plate 103, and adjustment wings 501. The central element 101 comprises an upper section 101a and a lower section 101b for supporting the load supporting members 102. The load supporting members 102 are positioned laterally on the lower section 101b of the central element 101. The load supporting members 102 enable a user to ascend and descend the automobile. The hook plate 103 is affixed to the upper end of the upper section 101a of the central element 101. The hook plate 103 secures the central element 101 to the automobile. The adjustment wings 501 enable the hook plate 103 to be fitted in stake pockets 401 of different sizes.

The user orients the upper section 101a of the central element 101 vertical to a flat surface and inclines the lower section 101b of the central element 101 with respect to the vertically oriented upper section 101a. The user then slides 702 the hook plate 103 through a stake pocket 401 of the automobile. The user may fit the hook plate 103 in the stake pocket 401 using the adjustment wings 501. The user may extend the adjustment wings 501 on both sides of the hook plate 103 and fasten the extended adjustment wings 501 to the hook plate 103 by inserting fasteners in openings 502 on the adjustment wings 501.

The user secures 703 the hook plate 103 to the stake pocket 401 of the automobile. Securing the hook plate 103 to the stake pocket 401 may comprise inserting a securing element 301 through an opening on the stake pocket 401 and into a tube 104 affixed atop the hook plate 103. The inserted securing element 301 secures the hook plate 103 to the automobile. The user then mounts 704 the load supporting members 102 of the access ladder 100, to access the elevated area on the automobile.

The access ladder 100 may be used at any elevated area on the automobile. For storage when not in use, the access ladder 100 may be secured to the automobile at a suitable location using brackets provided on the access ladder 100 to secure the access ladder 100 to the automobile. For example, the securing element 301 may be inserted through an aperture in the brackets and an aperture in the automobile to secure the access ladder 100 to the automobile. A padlock may also be used through an aperture of the brackets and an aperture in the automobile to secure the access ladder 100 to the automobile. The access ladder 100 may also be mounted on the automobile or placed in a tool box or housed in a cargo bay when not in use.

Consider the following example. John drives a trailer truck. John carries packages in the trailer of his truck and delivers the packages to different destinations. John needs to climb into the trailer of his truck at each destination to find the correct package to deliver. The trailer of his truck is at a considerable height from the ground. John may use the tires, the rear fender, or anchors on the body of his truck as footholds to climb into the trailer. John may slip and fall off the footholds while climbing into the truck, thereby injuring himself. While alighting, John may simply jump off the trailer to the ground. Repeatedly jumping to the ground may strain and injure his body.

To prevent injuries and for ease of boarding and alighting, John may use the access ladder 100 illustrated in FIG. 1, FIG. 2, and FIG. 4. John slides the hook plate 103 through a stake pocket 401 on his truck. If the stake pocket 401 is larger than the hook plate 103, John uses the adjustment wings 501 illustrated in FIG. 5 to fit the hook plate 103 in the stake pocket 401. John then inserts the securing element 301 into the tube 104. The access ladder 100 is now ready to be mounted. John ascends the load supporting members 102 of the access ladder 100 and boards the trailer of his truck.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A portable apparatus for accessing an elevated area on an automobile, comprising:
a central element comprising an upper section and a lower section for supporting a plurality of load supporting members;
a hook plate affixed to an upper end of said upper section of said central element, wherein said hook plate secures the central element to said automobile; and
said load supporting members laterally positioned on said lower section of the central element, wherein the load supporting members enable a user to access said elevated area on the automobile and to ascend and descend the automobile.

2. The portable apparatus of claim 1, further comprising a tube affixed atop said hook plate.

3. The portable apparatus of claim 2, further comprising a securing element inserted in said tube to secure the hook plate to the automobile.

4. The portable apparatus of claim 1, wherein the upper section is oriented vertical to a flat surface.

5. The portable apparatus of claim 1, wherein the lower section is inclined with respect to the upper section for enabling said user to ascend and descend the automobile using the load supporting members with comfort and ease.

6. The portable apparatus of claim 1, wherein the load supporting members are positioned horizontally and perpendicularly to the lower section of the central element, wherein the load supporting members are alternately placed in opposite directions on the lower section of the central element.

7. The portable apparatus of claim 1, wherein the hook plate fits within a stake pocket of the automobile, wherein the hook plate fitted into said stake pocket bears load of the portable apparatus and said user.

8. The portable apparatus of claim 1, further comprising a bracket for securing the hook plate to the automobile in absence of a stake pocket in the automobile.

9. The portable apparatus of claim 1, further comprising adjustment wings provided on the hook plate and extended on both sides of the hook plate for fitting the hook plate in stake pockets of different sizes provided on the automobile.

10. The portable apparatus of claim 9, wherein said adjustment wings comprise openings for inserting fasteners, wherein said fasteners fasten the adjustment wings to the hook plate after said extension.

11. A method of accessing an elevated area on an automobile, comprising the steps of:
providing a portable apparatus comprising:
a central element comprising an upper section and a lower section for supporting a plurality of load supporting members;
a hook plate affixed to an upper end of said upper section of said central element, wherein said hook plate secures the central element to said automobile; and
said load supporting members laterally positioned on said lower section of the central element, wherein the load supporting members enable a user to ascend and descend the automobile;
sliding the hook plate through a stake pocket of the automobile;
securing the hook plate to said stake pocket of the automobile; and
mounting the load supporting members by a user to access said elevated area on the automobile;
whereby the elevated area on the automobile is accessed using said portable apparatus.

12. The method of claim 11, further comprising the step of orienting the upper section of the central element vertical to a flat surface and inclining the lower section of the central element with respect to said vertically oriented upper section, prior to sliding the hook plate through the stake pocket of the automobile.

13. The method of claim 11, wherein said step of securing the hook plate to the stake pocket comprises inserting a securing element through an opening on the stake pocket and into a tube affixed atop the hook plate, wherein said inserted securing element secures the hook plate to the automobile.

14. The method of claim 11, wherein the portable apparatus further comprises adjustment wings provided on the hook plate for fitting the hook plate in stake pockets of different sizes provided on the automobile.

15. The method of claim 14, wherein said adjustment wings are extended on both sides of the hook plate and fastened by inserting fasteners in openings on the adjustment wings.
